(19) United States
(12) Patent Application Publication
(10) Pub. No.: US 2026/0302020 A1
(43) Pub. Date: Oct. 1, 2026

(54) FERRITE SINTERED BODY AND ELECTRONIC DEVICE USING THEREOF

(71) Applicant: TDK Corporation, Tokyo (JP)

(72) Inventors: Takeshi SHIBAYAMA, Tokyo (JP); Hidenobu UMEDA, Tokyo (JP); Yukio TAKAHASHI, Tokyo (JP); Masashi SHIMOYASU, Tokyo (JP); Daiki KATO, Tokyo (JP)

(73) Assignee: TDK Corporation, Tokyo (JP)

(21) Appl. No.: 19/577,463

(22) Filed: Mar. 25, 2026

(30) Foreign Application Priority Data
Mar. 27, 2025 (JP) 2025-054099
Sep. 25, 2025 (JP) 2025-159222

(51) Int. Cl. H01F 1/34; C04B 35/26

(52) U.S. Cl. CPC H01F 1/344; C04B 35/265

(57) ABSTRACT

A ferrite sintered body, including: boron oxide, an amount of boron oxide in an area C2 near a surface of the ferrite sintered body being smaller than an amount of boron oxide at a center area C1 of the ferrite sintered body.

### TECHNICAL FIELD

The present disclosure relates to a ferrite sintered body and an electronic device using thereof.

### BACKGROUND

Electronic devices such as multilayer coil devices use a ferrite sintered body including a coil conductor. In order to acquire a high permeability by facilitating a grain growth of particles configuring the sintered body, boron oxide (B₂O₃) or borosilicate glass (B₂O₃—SiO₂ glass) is added to a magnetic material.

Patent Document 1 discloses that adding a predetermined amount of borosilicate glass to a NiCuZn ferrite material enables to fire a temperature around 900° C., and also enables to attain a ferrite sintered body having a high permeability and a high Curie temperature (Tc).

However, for a conventional ferrite sintered body, it was difficult to improve high temperature humidity resistance reliability (a reliability under a high temperature and high humidity condition) and suppress a plating elongation without lowering a permeability.

### PRIOR ART DOCUMENT

### Patent Document

Patent Document 1: JP2019-123642 (A)

### SUMMARY

The object of the present disclosure is to provide a ferrite sintered body having excellent high temperature humidity resistance reliability and plating elongation suppressing property without lowering a permeability. Also, the object of the present disclosure is to provide an electronic device using such ferrite sintered body.

In order to achieve such object, the ferrite sintered body according to one embodiment of the present disclosure includes:
boron oxide, an amount of boron oxide near a surface of the ferrite sintered body being smaller than an amount of boron oxide at a center area of the ferrite sintered body.

Such ferrite sintered body achieves excellent high temperature humidity resistance reliability and plating elongation suppressing property without lowering a permeability. The reason for this is thought as discussed below. An amount of boron oxide is high in the center area of the ferrite sintered body, and even in the case firing is conducted at a low temperature, it is possible to acquire a high permeability. Also, the amount of boron oxide, which relatively easily absorbs moisture, is relatively low near the surface of the ferrite sintered body; thus, damages and corrosion of the ferrite sintered body caused by humidity is prevented, and thus, it is thought that the high temperature humidity resistance reliability is improved.

Preferably, the amount of boron oxide near the surface of the ferrite sintered body represented by α1 and the amount of boron oxide at the center area of the ferrite sintered body represented by α2 satisfy a relation of α2−α1 of 4 ppm or greater. By satisfying such range, the high temperature humidity resistance reliability is improved even more, and the plating elongation suppressing property is also improved even more without lowering the permeability.

Further, α2−α1 may be 250 ppm or less. By satisfying such range, the high temperature humidity resistance reliability and an inductance can be maintained in a favorable range.

Also, in the present specification, “an amount of boron oxide” refers to an amount in terms of B₂O₃ which is obtained by converting a quantitative amount of B (boron) detected using LA-ICP-MS. The form in the actual sample is not necessarily limited to a pure B₂O₃. Boron oxide includes other compounds containing B.

The ferrite sintered body may further include silicon oxide. In such case, preferably, an amount of silicon oxide near the surface of the ferrite sintered body may be greater than an amount of silicon oxide at the center area of the ferrite sintered body.

Preferably, the amount of silicon oxide near the surface of the ferrite sintered body represented by β1 and the amount of silicon oxide at the center area of the ferrite sintered body represented by β2 may satisfy a relation of β|-β2 of 10 ppm or greater. By satisfying such range, the high temperature humidity resistance reliability is improved even more, and the plating elongation suppressing property is also improved even more without lowering the permeability.

Also, in the present specification, “an amount of silicon oxide” refers to an amount obtained in terms of SiO₂ which is obtained by converting a quantitative amount of Si (silicon) detected using LA-ICP-MS. The form in the actual sample is not necessarily limited to a pure SiO₂. Silicon oxide includes other compounds containing Si.

A ferrite sintered body according to another embodiment of the present disclosure includes: lithium oxide, an amount of lithium oxide near a surface of the ferrite sintered body being smaller than an amount of lithium oxide at a center area of the ferrite sintered body.

Such ferrite sintered body can also achieve excellent high temperature humidity resistance reliability and plating elongation suppressing property without lowering the permeability.

Preferably, the amount of lithium oxide near the surface of the ferrite sintered body represented by γ1 and the amount of lithium oxide at the center area of the ferrite sintered body represented by γ2 may satisfy a relation of γ2−γ1 of 4 ppm or greater. By satisfying such range, the high temperature humidity resistance reliability is improved even more, and the plating elongation suppressing property is also improved even more without lowering the permeability.

Further, γ2−γ1 may be 440 ppm or less. By satisfying such range, the high temperature humidity resistance reliability and an inductance can be maintained in a favorable range.

Also, in the present specification, “an amount of lithium oxide” refers to an amount in terms of Li₂O which is obtained by converting a quantitative amount of Li (lithium) detected using LA-ICP-MS. The form in the actual sample is not necessarily limited to a pure Li₂O. Lithium oxide includes other compounds containing Li.

Preferably, the ferrite sintered body may be configured of a Ni—Cu—Zn based ferrite.

An electronic device according to one embodiment of the present disclosure includes: a magnetic element body and a coil conductor installed in the magnetic element body, wherein the magnetic element body includes any one of the above-mentioned ferrite sintered body.

This electronic device achieves excellent high temperature humidity resistance reliability and plating elongation suppressing property without lowering a permeability.

### BRIEF DESCRIPTION DRAWINGS

FIG. 1 is a schematic cross-sectional view of a multilayer coil device according to one embodiment of the present disclosure.

FIG. 2 is a schematic cross-sectional view of an area II shown in FIG. 1.

FIG. 3A is a schematic cross-sectional view showing part of manufacturing steps of the coil device shown in FIG. 1.

FIG. 3B is a schematic cross-sectional view showing a subsequent step of the step shown in FIG. 3A.

FIG. 4A is a schematic cross-sectional view showing part of manufacturing steps of the coil device according to a method different from that shown in FIG. 3A.

FIG. 4B is a schematic cross-sectional view showing a subsequent step of the step shown in FIG. 4A.

### DETAILED DESCRIPTION

### First Embodiment

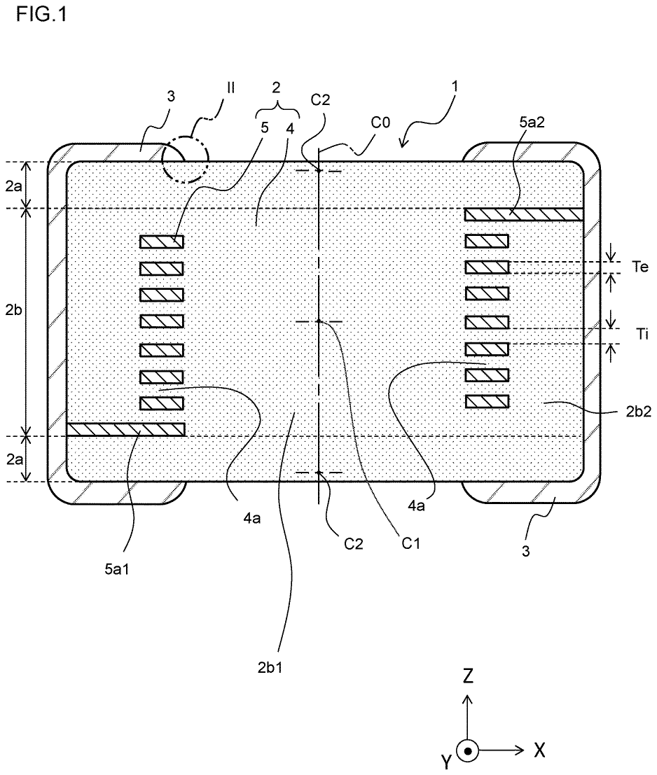

Below describes a multilayer coil device 1 shown in FIG. 1 as one example of a multilayer electronic device having a ferrite sintered body according to the present embodiment.

As shown in FIG. 1, for example, the multilayer coil device 1 according to the present embodiment may be suitably used as an inductor, and it includes an element main body 2 and a terminal electrode 3. The element main body 2 has a configuration which include a coil conductor layer 5 embedded three dimensionally and spirally in a magnetic element body (ferrite sintered body) 4. At both ends of the element main body 2 along the X-axis, terminal electrodes 3 are formed. The terminal electrodes 3 are connected with the coil conductor layer 5 via lead electrodes 5a1 and 5a2.

Note that, the X, Y, and Z-axes are perpendicular to each other in FIG. 1 and in figures described later. Also, in the present embodiment, “inside” refers to a side closer to the center area C1 of the multilayer coil device 1, and “outside” refers to a side away from the center area C1 of the multilayer coil device 1.

A material of the terminal electrode 3 is not particularly limited as long as it is an electrical conductor. Examples include Ag, Cu, Au, Al, Ag alloy, and Cu alloy. Preferably, Ag may be particularly used as it is inexpensive and has a low resistance. The terminal electrode 3 may contain glass frit. Also, the terminal electrode 3 is formed on the element main body 2, and the terminal electrode 3 may have a multilayer structure including a underlayer made of at least one of the above-mentioned metals or made of a combination of the at least one metals and the glass frit, and a resin layer made of a conductive resin formed on the underlayer.

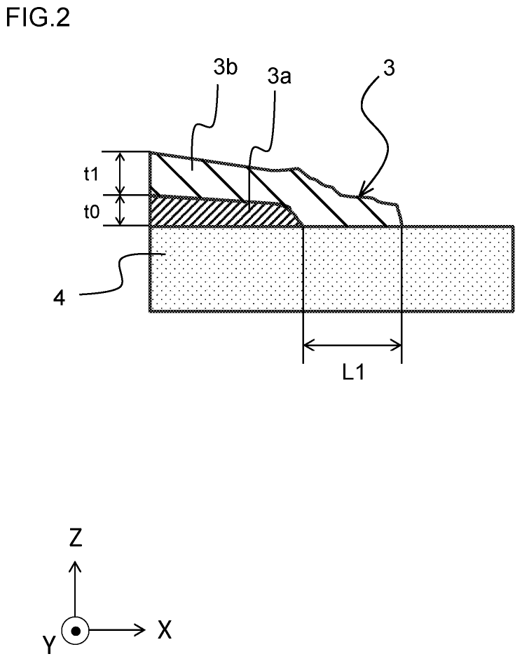

A type of a metal included in the conductive resin is not particularly limited. Examples include Ag. Also, as shown in FIG. 2, the terminal electrode 3 may include one layer of plating layer 3b or a plurality of plating layers on a surface of the underlayer 3a. Examples of the plating layer include, a Cu plating, a Ni plating, a Sn plating, a Cu—Ni—Sn plating, and/or a Ni—Sn plating.

In this embodiment, for example, the underlayer 3a is configured of an Ag paste layer, and the plating layer 3b is configured of a copper layer. However, the underlayer 3a and the plating layer 3b are not particularly limited to this configuration.

A thickness t0 of the underlayer 3a and a thickness t1 of the plating layer 3b are also not particularly limited.

Materials of the coil conductor layer 5 and the lead electrodes 5a1 and 5a2 may be any material as long as it is made of an electrical conductor. Examples include Ag, Cu, Au, Al, Ag alloy, and Cu alloy. Preferably, Ag may be particularly used as it is inexpensive and has a low resistance. The coil conductor layer 5 may include glass frit.

The number of turns of the coil conductor layer 5 around the center axis is not particularly limited, and for example, it may be 1.5 to 15.5 turns. Also, a thickness Te of the coil conductor layer 5 is not particularly limited, and it may be 5 to 60 μm.

As shown in FIG. 1, the element main body 2 can be divided into an exterior region 2a, an interior region 2b, and an exterior region 2a from a lower side along a center line (a winding axis of the coil conductor layer 5) C0 of the element main body 2 which is parallel to the Z-axis. In other words, the element main body 2 can be divided into the interior region 2b where the coil conductor layer 5 is embedded, and the exterior regions 2a and 2a disposed on top of and below the interior region 2b along the center line (Z-axis direction) C0 and where the coil conductor layer 5 is not embedded.

Specifically, across a virtual line which is perpendicular to a center axis direction (the Z-axis direction) and along outsides of the lead electrodes 5a1 and 5a2, the areas disposed outside along the center axis are deemed the exterior regions 2a and 2a, and the area at the inside is deemed the interior region 2b. In the present embodiment, the range of the interior region 2b includes the lead electrodes 5a1 and 5a2.

Also, in the present embodiment, the interior region 2b can be divided into a coil conductor inside region 2b1 disposed at the inside of the coil conductor layer 5 and a coil conductor outside region 2b2 disposed at the outside of the coil conductor layer 5.

In the present embodiment, a thickness Ti in the Z-axis direction of a magnetic material layer 4a is not particularly limited, and it may be 100 μm or less, 50 μm or less, 30 μm or less, 20 μm or less, 16 μm or less, 15 μm or less, 10 μm or less, 8 μm or less, 4 μm or less, 3 μm or less, or 2 μm or less.

The composition of the magnetic element body 4 including the magnetic material layer 4a is configured of a Ni—Cu—Zn-based ferrite which includes, for example, iron oxide, copper oxide, zinc oxide, and nickel oxide as a main component and at least includes boron oxide (B₂O₃) as a subcomponent.

An amount of iron oxide in 100 mol % of the main component is not particularly limited, and it may be 35 to 51 mol %, or preferably 48 to 50 mol % in terms of Fe₂O₃. By having the amount of iron oxide within the above-mentioned range, the ferrite sintered body having a high permeability can be obtained. Also, when the amount of iron oxide is too large, a sintering property may be lowered. Particularly, a sintering density during low temperature sintering tends to decline, and also an electrical resistivity tends to decline. When the amount of iron oxide is too low, a high permeability may not be achieved.

An amount of copper oxide in 100 mol % of the main component is not particularly limited, and it may be 4 to 13 mol %, or preferably 8 to 12 mol % in terms of CuO. By having the amount of copper oxide within the above-mentioned range, the ferrite sintered body which can be sintered at low temperature can be obtained. When the amount of copper oxide is too low, a sintering property is lowered. Particularly, a sintering density during low temperature sintering may decline.

An amount of zinc oxide in 100 mol % of the main component is not particularly limited, and it may be 1 to 35 mol %, or preferably 26 to 31 mol % in terms of ZnO. By having the amount of zinc oxide within the above-mentioned range, the ferrite sintered body having a high Curie temperature (Tc) and a high permeability can be obtained. The larger the amount of zinc oxide, the higher the initial permeability tends to be; and the higher the initial permeability, the more suitable it is as an inductor. If the amount of zinc oxide is too large, the Curie temperature tends to decrease.

The remainder of the main component is configured of nickel oxide.

In addition to the above-mentioned main component, the ferrite sintered body according to the present embodiment contains boron oxide as a subcomponent. The subcomponent may further contain silicon oxide and zirconium oxide.

An amount of boron oxide with respect to 100 mol % of the main component is not particularly limited, and preferably it may be 5 to 500 ppm, may be 10 to 250 ppm, or may be 20 to 200 ppm in terms of B₂O₃. By having the amount of boron oxide within the above-mentioned range, the ferrite sintered body having a high permeability can be obtained. When the amount of boron oxide is too large, a grain growth during firing may be suppressed and the permeability may decline. Note that, boron oxide may be added preferably in a form of glass including boron.

In the present embodiment, boron oxide does not evenly exist in the magnetic element body 4 shown in FIG. 1 made of the ferrite sintered body. The amount of boron oxide in an area C2 near the surface of the element body 4 is smaller than the amount of boron oxide at the center area C1 of the element body 4. In the present embodiment, the center area C1 of the element body 4 is defined as an area within a predetermined first measuring radius from the position where the center of the element body 4 in the Z-axis direction, the center of the element body 4 in the X-axis direction, and the center of the element body 4 in the Y-axis direction match or from the position that these centers are being closest to each other. The predetermined first measuring radius, for example, may be within a range of 1/10 to ½, or 2/10 to ⅓ of a distance of the interior region 2b along the Z-axis.

In the present embodiment, the area C2 near the surface of the element body 4 is defined as an area within a predetermined second measuring radius which is from the position at the inside of the element body 4 by a predetermined distance along a center line C0 along the Z-axis of the coil device 1 from the surface along the Z-axis direction. The predetermined second measuring radius, for example, may be within a range of 1/10 to ½, or 2/10 to ⅓ of a distance of the exterior region 2a along the Z-axis.

In the present embodiment, the area C2 near the surface of the element body 4 may be defined as an area within the predetermined second measuring radius by a predetermined distance along a virtual line passing the center area C1 and being parallel to the Y-axis from the position at the inside of the element body 4 from the surface along the Y-axis.

In the present embodiment, the amount of boron oxide (in terms of B₂O₃) near the area C2 near the surface of the element body 4 represented by α1 and the amount of the boron oxide (in terms of B₂O₃) at the center area C1 of the element body 4 represented by α2 may preferably satisfy the relation of α2−α1 of 4 ppm or greater, 10 ppm or greater, or 15 ppm or greater. Note that, α2−α1 may preferably be 250 ppm or less, 150 ppm or less, 70 ppm or less, or 50 ppm or less. By satisfying such range, the high temperature humidity resistance reliability is improved even more, and the plating elongation suppressing property is also improved even more without lowering the permeability.

An amount of silicon oxide (in terms of SiO₂) with respect to 100 mol % of the main component is not particularly limited, and preferably it may be 0 to 900 ppm, may be 0 to 500 ppm, or may be 0 to 250 ppm. By having the amount of silicon oxide within the above-mentioned range, the ferrite sintered body having a good sinterability can be obtained. Also, when the amount of silicon oxide is too large, the sintering property is lowered. Particularly, the sintering density during low temperature sintering may decline.

In the present embodiment, silicon oxide does not evenly exist in the magnetic element body 4 shown in FIG. 1 made of the ferrite sintered body. The amount of silicon oxide close to the area C2 near the surface of the element body 4 is larger than the amount of silicon oxide at the center area C1 of the element body 4.

In the present embodiment, the amount of silicon oxide (in terms of SiO₂) close to the area C2 near the surface of the element body 4 represented by β1 and the amount of the silicon oxide (in terms of SiO₂) at the center area C1 of the element body 4 represented by β2 may preferably satisfy the relation of β1−β2 of 10 ppm or greater, or 40 ppm or greater. Preferably, β2−β1 may preferably be 150 ppm or less. By satisfying such range, the high temperature humidity resistance reliability is improved even more, and the plating elongation suppressing property is also improved even more without lowering the permeability.

An amount of zirconium oxide (in terms of ZrO₂) with respect to 100 mol % of the main component is not particularly limited, and preferably it may be 0 to 1100 ppm, may be 5 to 1100 ppm, may be 5 to 900 ppm, or may be 5 to 700 ppm. By having the amount of zirconium oxide within the above-mentioned range, the sinterbility is enhanced even more.

In the ferrite sintered body according to the present embodiment, the amount of each component configuring the main component is controlled within the above-mentioned range, and in addition to this, the ferrite sintered body contains the compounds such as boron oxide as the subcomponent in the predetermined range. As a result, a sintering temperature can be lowered; thus, metals having relatively low melting point such as Ag can be used as an internal conductor being fired together. Further, the ferrite sintered body obtained through low temperature firing has a high initial permeability and a high Curie temperature Tc.

Further, in the ferrite sintered body according to the present embodiment, instead of boron oxide as the subcomponent, lithium oxide can be used, and also boron oxide and lithium oxide can be used together. An amount of lithium oxide (in terms of Li₂O) with respect to 100 parts by weight of the main component is not particularly limited, and preferably it may be 5 to 10000 ppm, may be 500 to 9000 ppm, or may be 1000 to 8000 ppm. By having the amount of lithium oxide within the above-mentioned range, the ferrite sintered body having a high permeability can be obtained. When the amount of lithium oxide is too large, a grain growth during firing may be suppressed and the permeability may decrease.

Moreover, in addition to the above-mentioned subcomponents, the ferrite sintered body according to the present embodiment may contain an additional component, such as manganese oxides (e.g., Mn₃O₄), tin oxides, magnesium oxides, and glass compounds, within a range which the effects of the present embodiment are not disturbed. The amount of the additional component is not limited and, for example, it may be 0.05 wt % to 10 wt %.

Moreover, the ferrite sintered body according to the present embodiment may include inevitable impurity elements and oxides thereof.

Examples of the inevitable impurity elements include C, S, Cl, As, Se, Br, Te, and I; main group metal elements such as, Na, Mg, Al, Ca, Ga, Ge, Sr, Cd, In, Sb, Ba, and Pb; and transition metal elements such as Sc, Ti, V, Cr, Y, Nb, Mo, Pd, Ag, Hf, and Ta. Preferably, the oxides of the inevitable impurity elements are contained in the ferrite composition in an amount of about 0.05 wt % or less.

Particularly, when a large amount of Na is included, the grain growth during sintering is suppressed, and the permeability may decline. Thus, the amount of Na in terms of Na₂O is preferably 200 ppm or less.

An average crystal grain size of crystal grains configuring the ferrite sintered body according to the present embodiment is not particularly limited, and preferably it may be 2 to 30 μm, may be 3 to 20 μm, or may be 4 to 10 μm.

Note that, the average crystal grain size refers to a median diameter (D50 grain size, 50% grain size) of a volume-based distribution calculated from the crystal grain sizes using a predetermined number of crystal grains. A cross-section surface of the ferrite sintered body appropriately treated using chemical etching or so, depending on needs, is observed using an optical microscopic or SEM, and the volumed-based distribution of crystal grain sizes of the predetermined number of crystal grains is calculated. Note that, the particle size of each crystal grain, for example, can be obtained as a circle equivalent diameter (Heywood diameter) which assumes that an area of each crystal grain corresponds to a circle. Also, the number of grains used for the measurement of the average crystal grain size is normally 100 or more.

A density of the ferrite sintered body according to the present embodiment is 4.90 to 5.30 g/cm³, may be 5.00 to 5.30 g/cm³, or preferably may be 5.10 to 5.30 g/cm³.

The density of ferrite sintered body is calculated from a dimension and a weight of the sintered body obtained by firing a molded body of a disc shape at 900° C.

The Curie temperature Tc of the ferrite sintered body according to the present embodiment may be 100° C. or higher, more preferably 125° C. or higher, or even more preferably 150° C. or higher. The Curie temperature Tc is measured based on JIS-C-2560-1,2.

A specific resistance p of the ferrite sintered body according to the present embodiment, preferably may be 10⁶ Ω·m or greater, more preferably 10⁷ Ω·m or greater, or even more preferably 10⁸ Ω·m or greater. The specific resistance ρ can be obtained by measuring a DC resistance value of the ferrite sintered body having In—Ga electrode. The specific resistance p can be measured using an IR meter.

The permeability u′ at frequency of 100 kHz of the ferrite sintered body according to the present embodiment may preferably be 1000 or higher, more preferably 1100 or higher, or even more preferably 1200 or higher. The permeability u′ is measured by wrapping a copper wire for ten turns around a ferrite sintered body having a toroidal core shape. The permeability u′ can be measured using an LCR meter. Measuring conditions are frequency of 100 kHz and at a temperature of 25° C.

Next, an example of a method of manufacturing a ferrite sintered body according to the present embodiment is described. First, starting raw materials (a raw material for the main component and a raw material for the subcomponent) are weighed so as to have a predetermined compositional proportion and then mixed to give a raw material mixture. Examples of mixing methods include a wet mixing method using a ball mill and a dry mixing method using a dry mixer. Note that, a starting material having an average particle size of 0.05 to 1.0 μm may be preferably used.

As the raw material for the main component, iron oxides (α-Fe₂O₃), copper oxides (CuO), zinc oxides (ZnO), nickel oxides (NiO), composite oxides, or the like can be used. In addition, various compounds which become the above-mentioned oxides or composite oxides by firing can be used. Examples of the substances which become the above-mentioned oxides by firing include simple metals, carbonates, oxalates, nitrates, hydroxides, halides, and organometallic compounds.

As the raw materials of the subcomponent, glasses containing boron oxide and having low melting point can be used. As such glasses, a B—Zn—Si-based glass can be used. In the B—Zn—Si-based glass, zinc oxide, silicon oxide, and other trace components may be included in addition to boron oxide. Part of the components included in such glasses may be lost during a calcination step and a firing step which are described later.

Next, the raw material mixture is calcined to give a calcined material. The calcination is carried out so as to cause a thermal decomposition of the raw materials, homogenization of the components, generation of ferrites, disappearance of ultrafine powder by sintering, and a grain growth to an appropriate particle size to convert the raw material mixture into a suitable form for subsequent steps. Such calcination may be preferably performed at a temperature 500 to 900° C. normally for 2 to 15 hours. The calcination is normally carried out in the atmosphere pressure (in air); however, it may be carried out in an atmosphere having an oxygen partial pressure lower than that of the atmospheric pressure. The raw materials of the main component and the raw materials of the subcomponents may be mixed before or after the calcination.

Next, the calcined material is pulverized to obtain a pulverized material. The pulverization is carried out by breaking an aggregation of the calcined material to obtain a powder having an appropriate sinterability. When the calcined material has a large aggregation, the calcined material is coarsely pulverized, and then a wet pulverization is carried out using a ball mill, an attritor, or the like. The wet pulverization is preferably carried out until the average particle size of the pulverized material becomes about 0.1 to 1.0 μm.

Next, using the obtained pulverized material, the multilayer inductor according to the present embodiment is manufactured. A method for manufacturing the multilayer inductor is not particularly limited, and for example, a sheet method, or a printing method is carried out as described in below; or a combination method of these may be used.

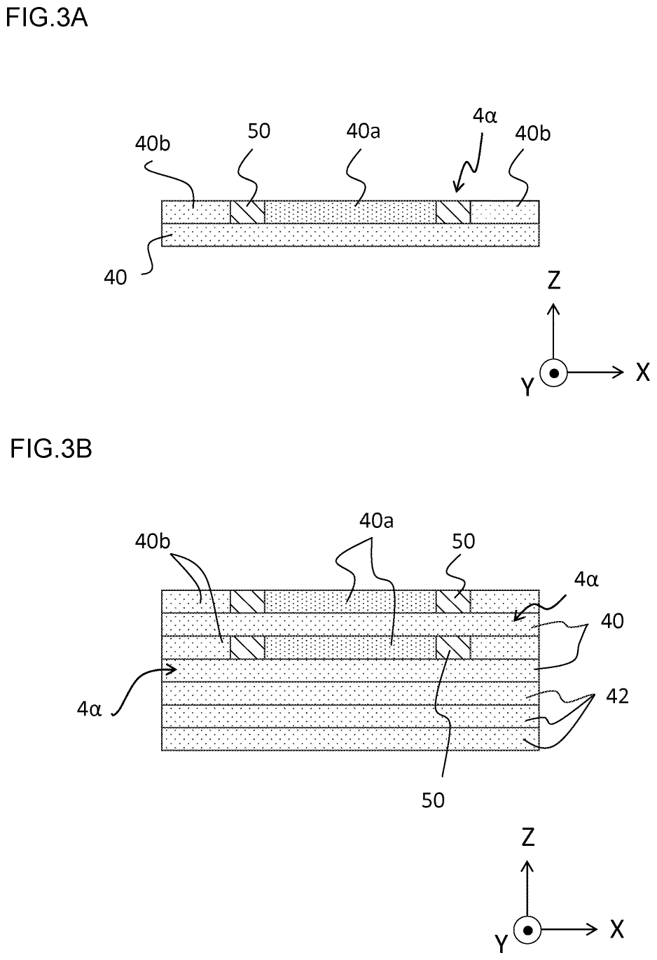

First, the obtained pulverized material is turned into a slurry with additives such as a solvent and a binder to prepare a ferrite paste. Then, this paste is used to form a green sheet. In the present embodiment, two types of green sheets which are an interior magnetic sheet 40 shown in FIG. 3A and an exterior magnetic sheet 42 shown in FIG. 3B are formed. The interior magnetic sheet 40 is a green sheet which becomes at least part of the interior region 2b shown in FIG. 1. The exterior magnetic sheet 42 is a green sheet which becomes at least part of the exterior region 2a shown in FIG. 1.

The interior magnetic sheet 40 and the exterior magnetic sheet 42 may be the green sheets having the same ferrite composition, or it may be the green sheets having the different ferrite compositions\. The exterior magnetic sheet 42 may contain silicon oxide, and preferably the exterior magnetic sheet 42 may be substantially free of boron oxide. The interior magnetic sheet 40 may or may not include silicon oxide, and the interior magnetic sheet 40 may be substantially free of boron oxide.

As shown in FIG. 3A, in the present embodiment, a predetermined pattern of a conductor pattern 50 which becomes the coil conductor layer 5 (including the lead electrodes 5a1 and 5a2) shown in FIG. 1 is printed on the surface of the interior magnetic sheet 40. The conductor pattern 50 is configured of a paste including a raw material mixture which becomes the coil conductor layer 5 shown in FIG. 1 after firing. At an inner side of the conductor pattern 50, a coil conductor inner part 40a is printed. At the same time, or before or after printing the coil conductor inner part 40a, a coil conductor outer part 40b is printed on an outer side of the conductor pattern 50.

The paste configuring the coil conductor inner part 40a may preferably include a ferrite composition, a main component being the same as (or may be different from) the ferrite composition configuring the interior magnetic sheet 40, and a subcomponent is different from that in the ferrite composition of the interior magnetic sheet 40. That is, the paste configuring the coil conductor inner part 40a contains a larger amount of boron oxide as the subcomponent or a subcomponent which becomes boron oxide after firing than that included in the interior magnetic sheet 40. The paste configuring the coil conductor inner part 40a contains a larger amount of silicon oxide as the subcomponent or a subcomponent which becomes silicon oxide after firing than that included in the interior magnetic sheet 40.

For example, as the ferrite composition of the interior magnetic sheet 40, a ferrite composition configured solely on the main component and not including the subcomponent is prepared, and the ferrite composition configuring the coil conductor inner part 40a may use a composition which is added with a B₂O₃—SiO₂-based glass as the subcomponent to the ferrite composition of the interior magnetic sheet 40.

As the B₂O₃—SiO₂-based glass, it is not particularly limited; and for example, it is configured of 4 to 25 wt % of B₂O₃, 0.5 to 79 wt % of SiO₂, and the remainder may be configured of Bi₂O₃, ZnO, MgO, Al₂O₃, Na₂O, K₂O, CaO, TiO₂, Cr₂O₃, MnO, SrO, SnO₂, BaO, CeO₂, WO3, etc. The B₂O₃—SiO₂-based glass may include other components. The B₂O₃—SiO₂-based glass added ferrite paste contains a ferrite (main component) as an inorganic component, the B₂O₃—SiO₂-based glass as the subcomponent, and an organic component including a resin and a solvent. The resin is selected accordingly from an ethyl cellulose resin, a butyral resin, an acrylic resin, etc. The solvent is selected accordingly from solvents such as terpineol, BDG, BC, etc., however, it may be any solvent other than these.

The paste configuring the coil conductor outer part 40b may preferably include a ferrite composition, a main component being the same as (or may be different from) the ferrite composition configuring the interior magnetic sheet 40, and a subcomponent being different from that included in the ferrite composition of the interior magnetic sheet 40. That is, the paste configuring the coil conductor outer part 40b is the same as the interior magnetic sheet 40 from the point that boron oxide or the subcomponent which becomes boron oxide after firing is preferably not included; however, as the subcomponent, silicon oxide or the subcomponent which becomes silicon oxide after firing is preferably included.

A stacking unit 4a shown in FIG. 3A is stacked in a plurality of layers on the exterior magnetic sheet 42 as shown in FIG. 3B. The exterior magnetic sheet 42 is further stacked on the multilayer unit 4a to give a green sheet multilayer body. The green sheet multilayer body is subjected to a binder removal step and a firing step; thereby, obtaining an element main body 2 in which a coil conductor layer 5, formed three-dimensionally and in a spiral shape, is provided with magnetic material layers 4a interposed between turns of the conductor layer 5, as shown in FIG. 1. Note that, the coil conductor layer 5 which each turn is close to each other along the Z-axis may be spirally connected using a through electrode, or may be spirally connected by printing the coil conductor layer 5 every half turn.

The firing step is carried out at a temperature lower than a melting point of the coil conductor and the lead electrodes 5a and 5b. When the coil conductor and the lead electrodes 5a and 5b are formed of Ag (melting point: 962° C.), preferably, the firing step may be carried out at a temperature of 850 to 920° C. A firing time is normally 1 to 5 hours or so. The firing step may be carried out under the atmospheric pressure (in air), or it may be carried out under an atmospheric pressure having an oxygen partial pressure lower than that of the atmospheric pressure. Further, the terminal electrodes 3 are formed at the both ends of the element main body 2, and the coil conductor layer 5 and the terminal electrodes 3 are connected via the lead electrodes 5a and 5b, thereby, the multilayer inductor can be obtained.

According to the method of the present embodiment, boron oxide included in the coil conductor inner part 40a exists in the coil conductor inside region 2b1 shown in FIG. 1, and during firing, boron oxide disperses in a direction away from C1. The coil conductor outer part 2a shown in FIG. 1 does not include boron oxide at the time of the green sheet multilayer body, and during firing, boron oxide disperses from the coil conductor inside region 2b1 to the direction away from C1. Consequently, the amount of boron oxide at the center area C1 of the magnetic element body 4 made of the ferrite sintered body is thought to become greater than the amount of boron oxide close to the area C2 near the surface of the magnetic element body 4. The amount of boron oxide at the center area C1 of the magnetic element body 4 may be controlled by how thin the coil conductor inner part 40a (and also the coil conductor outer part 40b) shown in FIG. 3A is in relative to the thickness of the interior magnetic sheet 40. Alternatively, the amount of boron oxide in the center area C1 can be controlled by adjusting a proportion of boron oxide included in the coil conductor inner part 40a.

This coil device 1 according to the present embodiment achieves excellent high temperature humidity resistance reliability and plating elongation suppressing property without lowering the permeability. Note that, the plating elongation suppressing property can be defined as described in below. For example, as shown in FIG. 2, a plating elongation L of the plating layer 3b along the X-axis from the end of the underlayer 3a of the terminal electrode 3 on the surface of the magnetic element body 4 is calculated based on a distance L1 which is from the end in the X-axis of the underlayer 3a along the surface of the magnetic element body 4 to the end of the outermost layer of the plating layer.

For example, when the plating layer includes the plurality of plating layers 3b to 3d, and each thickness is respectively defined as t1, t2, and t3, the plating elongation L of the plating layers 3b to 3d is defined as L1−(t1+t2+t3). In the present embodiment, preferably the plating elongation L may be 100 μm or less, 50 μm or less, 40 μm or less, 32 μm or less, 20 μm or less, 12 μm or less, or 6 μm or less.

### Second Embodiment

Below describes the second embodiment, and unless mentioned otherwise, it is basically the same as the first embodiment.

The composition of the magnetic element body 4 including the magnetic material layer 4a is configured of a Ni—Cu—Zn based ferrite which, for example, includes iron oxide, copper oxide, zinc oxide, and nickel oxide as a main component and at least includes lithium oxide (Li₂O) as a subcomponent.

In addition to the main component, the ferrite sintered body according to the present embodiment contains lithium oxide as the subcomponent. Furthermore, silicon oxide, zirconium oxide, etc., may be further included as the subcomponent.

An amount of lithium oxide (in terms of Li₂O) with respect to 100 parts by weight of the main component is not particularly limited, and preferably it may be 5 to 10000 ppm, may be 500 to 9000 ppm, or may be 1000 to 8000 ppm. By having the amount of lithium oxide within the above-mentioned range, the ferrite sintered body having a high permeability can be obtained. When the amount of lithium oxide is too large, a grain growth during firing may be suppressed and the permeability may decrease. Note that, lithium oxide is preferably added in a form of Li₂CO₃.

In the present embodiment, lithium oxide does not evenly exist in the magnetic element body 4 shown in FIG. 1 made of the ferrite sintered body. The amount of lithium oxide close to the area C2 near the surface of the element body 4 is smaller than the amount of lithium oxide at the center area C1 of the element body 4.

In the present embodiment, the amount of lithium oxide (in terms of Li₂O) near the area C2 near the surface of the element body 4 represented by γ1 and the amount of lithium oxide (in terms of Li₂O) at the center area C1 of the element body 4 represented by γ2 may preferably satisfy the relation of γ2−γ1 of 4 ppm or greater, 10 ppm or greater, or 15 ppm or greater. Note that, γ2−γ1 may preferably be 440 ppm or less, 250 ppm or less, 150 ppm or less, 70 ppm or less, or 50 ppm or less. By satisfying such range, the high temperature humidity resistance reliability is improved even more, and the plating elongation suppressing property is also improved even more without lowering the permeability.

An amount of silicon oxide (in terms of SiO₂) with respect to 100 mol % of the main component is not particularly limited, and preferably it may be 0 to 900 ppm, may be 0 to 500 ppm, or may be 0 to 250 ppm. By having the amount of silicon oxide within the above-mentioned range, the ferrite sintered body having a good sinterability can be obtained. When the amount of silicon oxide is too large, a sintering property is lowered. Particularly, a sintering density during low temperature sintering may decline.

An amount of zirconium oxide (in terms of ZrO₂) with respect to 100 mol % of the main component is not particularly limited, and preferably it may be 0 to 1100 ppm, may be 5 to 1100 ppm, may be 5 to 900 ppm, or may be between 5 to 700 ppm. By having the amount of zirconium oxide within the above-mentioned range, the sinterbility is enhanced even more.

In the ferrite sintered body according to the present embodiment, the amount of each component configuring the main component is controlled within the above-mentioned range, and in addition to this, the ferrite sintered body contains the compounds such as lithium oxide as the subcomponent in the predetermined ranges.

As a result, a sintering temperature can be lowered; thus, metals having relatively low melting point such as Ag can be used as an internal conductor which is fired together. Further, the ferrite sintered body obtained through low temperature firing has a high initial permeability and a high Curie temperature Tc.

### Third Embodiment

Below describes the third embodiment, and unless mentioned otherwise, it is basically the same as the first embodiment.

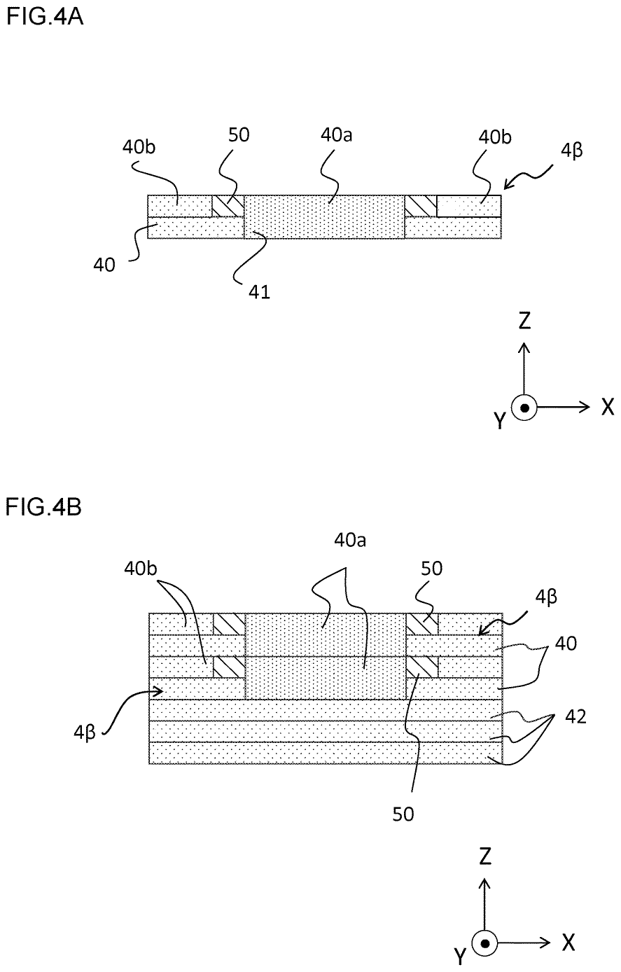

The present embodiment is basically the same as the first embodiment except that instead of the method shown in FIG. 3A and FIG. 3B, a method shown in FIG. 4A and FIG. 4B are used to manufacture the multilayer coil device 1 shown in FIG. 1, and the description of the common parts are skipped.

As shown in FIG. 4A, in the present embodiment, before or after printing a predetermined pattern of a conductor pattern 50, which becomes the coil conductor layer 5 (including the lead electrodes 5a1 and 5a2) shown in FIG. 1, on the surface of the interior magnetic sheet 40, a hole (it may be a through hole) 41 is formed to the interior magnetic sheet 40 to the inner side of the conductor pattern 50. Similarly to the aforementioned embodiments, for example, the interior magnetic sheet 40 may be formed on a support sheet such as a PET film (not shown in the figure).

Then, at the inner side of the conductor pattern 50, a coil conductor inner part 40a is printed. At this time, the coil conductor inner part 40a also enters inside the hole 41 of the interior magnetic sheet 40. At the same time, or before or after printing the coil conductor inner part 40a, a coil conductor outer part 40b is printed on an outer side of the conductor pattern 50.

A stacking unit 4ß shown in FIG. 4A is stacked in a plurality of layers on the exterior magnetic sheet 42 as shown in FIG. 4B, and the exterior magnetic sheet 42 is further stacked. Thereby, a green multilayer body is obtained. The green sheet multilayer body is subjected to a binder removal step and a firing step; thereby, an element main body 2 is obtained in which a coil conductor layer 5, formed three-dimensionally and in a spiral shape, is provided with magnetic material layers 4a interposed between turns of the conductor layer 5, as shown in FIG. 1. Note that, the coil conductor layer 5 which each of the turns are close to each other in the Z-axis direction may be spirally connected using a through electrode, or may be spirally connected by printing the coil conductor layer 5 every half turn.

The firing step is carried out similarly to the aforementioned embodiment. According to the method of the present embodiment, boron oxide included in the coil conductor inner part 40a disperses, during firing, into the coil conductor inner region 2b1 shown in FIG. 1. Thus, the amount of boron oxide at the center area C1 of the magnetic element body 4 made of the ferrite sintered body is thought to become greater than the amount of boron oxide close to the area C2 near the surface of the magnetic element body 4. The amount of boron oxide at the center area C1 of the magnetic element body 4 may be controlled by adjusting the thickness of the coil conductor inner part 40a (and also the coil conductor outer part 40b) shown in FIG. 3A in relative to the thickness of the interior magnetic sheet 40. Alternatively, the amount of boron oxide in the center area C1 of the magnetic element body 4 can be controlled also by adjusting a proportion of boron oxide included in the coil conductor inner part 40a. Alternatively, the amount of boron oxide in the center area C1 of the magnetic element body 4 can be controlled by adjusting a depth of the hole 41.

This coil device 1 according to the present embodiment also has excellent high temperature humidity resistance reliability and plating elongation suppressing property without lowering the permeability.

Hereinabove, the embodiments of the present disclosure have been described; however, the present disclosure is not limited to these embodiments in any way, and various embodiments within the range which does not exceed the gist of the present disclosure are possible.

For example, in the above-mentioned embodiment, the winding axis of the coil conductor layer 5 is parallel to the Z-axis and is parallel to the stacking direction of the coil conductor layer 5; however, in other embodiments, the winding axis of the coil conductor layer 5 may be parallel to the X-axis. That is, the coil conductor layer 5 and the magnetic material layer 4a may be stacked along the X-axis.

Also, in the above-mentioned embodiments, the composition of the magnetic element body 4 is the Ni—Cu—Zn-based ferrite including iron oxide, copper oxide, zinc oxide, and nickel oxide as the main component, however, in other embodiments, it may be a Mn—Zn-based ferrite, a Li-based ferrite, a Mg-based ferrite, etc.

Further, a coating layer such as a glass coating layer may be formed on the surface of the magnetic element body 4.

Also, the electronic device using the ferrite sintered body of the present disclosure is not limited to the above-mentioned coil device. For example, it may be a LC composite electronic device, and the ferrite sintered body of the present disclosure may be used to the inductor part of the LC composite electronic device.

### EXAMPLES

Hereinafter, the present invention is described based on more detailed examples, but the present disclosure is not limited to these examples.

### Example 1

NiO, CuO, ZnO, and Fe₂O₃ were prepared, and these materials were blended. Then, calcination and pulverization were carried out to prepare a raw material powder. Note that, a blending ratio of each compound was, NiO: 11.5 mol %, CuO: 9.5 mol %, ZnO: 30 mol %, and Fe₂O₃: 49 mol %. A resin binder, a solvent, a plasticizer, and a dispersant were added to the obtained raw material powder to prepare a main component ferrite paste. SiO₂ glass was added to the above-mentioned main component ferrite paste to prepare an exterior ferrite paste. This exterior ferrite paste was printed on a PET film for several times to form an exterior magnetic sheet 42 configuring an exterior region 2a. An amount of SiO₂ in the exterior ferrite paste was adjusted to be 640 ppm with respect to 100 parts by weight of the main component.

Also, a stacking unit 4a shown in FIG. 3A which configures an interior region 2b shown in FIG. 1 was prepared in the following steps. First, the main component ferrite pastes not including a subcomponent was printed on the PET film not shown in the figure to form an interior magnetic sheet 40. On the interior magnetic sheet 40, a conductor pattern 50 made of Ag was printed to configure a coil conductor layer 5.

Using a printing method, a ferrite paste added with B₂O₃—SiO₂ glass was applied to a coil conductor inner part 40a so that a coating thickness was 10.0 μm. An amount of B₂O₃ in the ferrite paste was adjusted to be 400 ppm with respect to 100 parts by weight of the main component, and an amount of SiO₂ was adjusted to be 1000 ppm with respect to 100 parts by weight of the main component. Using a printing method, a ferrite paste added with SiO₂ glass was applied to a coil conductor inner part 40b so that a coating thickness was 10 μm. A thickness of the interior magnetic sheet 40 was 10 μm, and a thickness of the coil conductor layer 5 was 20 μm.

As shown in FIG. 3B, a stacking unit 4α was stacked on the exterior magnetic sheet 42 while changing the arrangement so that the number of turn was 7.5 turns. Thereby, the interior magnetic sheet 40 was formed. Then, the exterior magnetic sheet 42 was further stacked to give a green multilayer body having a thickness of 0.8 mm. The green multilayer body obtained as such was cut into a shape of 1.6 mm×0.8 mm to obtain a green multilayer coil.

Next, the obtained green multilayer coil was subjected to a binder removal treatment under inert atmosphere (N₂ gas atmosphere) at 400° C. Then, firing was performed under a reducing atmosphere (a mixed gas atmosphere of N₂ gas and H₂ gas (hydrogen concentration of 1.0%)) at 900° C. for one hour to obtain a fired body.

To the both side surfaces of the obtained sintered body, a terminal electrode paste was applied and dried, then a baking treatment was carried out under atmosphere having oxygen partial pressure of 1% at 700° C. for 1 hour; thereby, an underlayer 3a of the terminal electrode 3 was formed. Then, electrolytic plating was carried out to form a Cu plating layer 3b on the underlayer 3a; thereby, a multilayer coil device 1 was obtained. An internal dimension of the obtained multilayer coil device 1 was a thickness (Te) of 15 μm and a thickness of an interlayer region (Ti) of 8 μm.

The obtained multilayer coil device was analyzed as described in below.

### <Composition Analysis>

A multilayer coil device was cut along the stacking direction, and a cross section was polished to give a polished surface. On the obtained cross section, the position on a center axis C0 which was 20 μm from the outer surface of the magnetic element body 4 (i.e., the area C2 near the surface of the element body 4) was subjected to a composition analysis using LA-ICP-MS, and the results were converted to values in terms of oxides (B₂O₃ and SiO₂); thereby, α1 and β1 were obtained. Likewise, the composition analysis was performed to a center area C1 of the magnetic element body 4 along the center axis C0, and thereby α2 and β2 were obtained. Table 1B shows the results. For each position, the composition of the main component was the same as the composition at the raw material stage.

### <Inductance (L)>

Regarding the obtained multilayer coil device, an inductance (L) was measured at f=2 MHz and I=0.1 A using a LCR meter (4285A made by HEWLETT PACKARD). The inductances of thirty multilayer coil devices were measured, and the average inductance L was obtained. Table 1B shows the results.

### <Reliability>

For the multilayer coil device, a current of 2.1 A was applied under the atmosphere of a temperature of 85° C. and a humidity of 85% to obtain a length of time which took the inductance L to reach 90% of the initial inductance. Table 1B shows the results.

### <Plating Elongation>

A thickness of the plating layer was obtained by observing an end of the terminal electrode of the multilayer coil device using SEM-EDS. For five or more positions on the outer surface of the terminal electrode having the plating layer, a virtual line was set which passes through the plating layer and reaches the outer surface of the magnetic element body 4, and a cross-section length of a plating layer 3b was obtained using image analysis. An average of the cross-section lengths of the plating layers were obtained to give a thickness T0 of the plating layer.

Also, a distance from the end of the terminal electrode to the end of the plating electrode was obtained, that is, a length L1 which was a length that the plating electrode being in direct contact with the magnetic element body was obtained. Then, a difference between L1 and T0 (L1−T0) was deemed the plating elongation. Table 1B shows the results.

### Examples 2 to 8

When forming the exterior magnetic sheet 42, the amount of SiO₂ in the ferrite paste added with SiO₂ glass was adjusted to be a value shown in Table 1A. When forming the coil conductor inner part 40a on the interior magnetic sheet 40, a coating thickness of the inner part ferrite paste added with B₂O₃—SiO₂ glass was adjusted to be a value shown in Table 1A.

When forming the coil conductor outer part 40b on the interior magnetic sheet 40, a coating thickness of the outer part ferrite paste added with SiO₂ glass was adjusted to be a value shown in Table 1A.

The multilayer coil device was manufactured similarly to Example 1 other than mentioned in above, and similar evaluations as in the case of Example 1 were carried out. Table 1B shows the results.

### Comparative Example 1

When forming the exterior magnetic sheet 42, the amount of SiO₂ in the ferrite paste was adjusted to be 590 ppm. The coil conductor inner part 40a and the coil conductor outer part 40b were not printed on the interior magnetic sheet 40, and the green multilayer body was manufactured. The multilayer coil device was manufactured similarly to Example 1 other than mentioned in above, and similar evaluations as in the case of Example 1 were carried out. Table 1B shows the results.

TABLE 1A

| | | | | | | | | | | | | | Exterior | | | | | |
|---|---|---|---|---|---|---|---|---|---|---|---|---|---|---|---|---|---|---|
| | Interior magnetic sheet | | | | | | Coil conductor | | | Coil conductor | | | magnetic sheet | | | | | |
| | Main | | | | Sub- | | inner part | | | outer part | | | Main | | | | Sub- | |
| | component | | | | component | | Printing | | | Printing | | | component | | | | component | |
| | (mol %) | | | | (ppm) | | (Paste | Coated | | (Paste | Coated | | (mol %) | | | | (ppm) | |
| | Fe₂O₃ | NiO | CuO | ZnO | B₂O₃ | SiO₂ | application) | amount | | application) | amount | | Fe₂O₃ | NiO | CuO | ZnO | B₂O₃ | SiO₂ |
| Comparative | 49.0 | 11.5 | 9.5 | 30.0 | 220.0 | 590.0 | No printing | | | No printing | | | 49.0 | 11.5 | 9.5 | 30.0 | 220.0 | 590.0 |
| example 1 | | | | | | | | | | | | | | | | | | |
| Example 1 | ↓ | ↓ | ↓ | ↓ | 0 | 0 | Printed | 10 | μm | Printed | 10 | μm | ↓ | ↓ | ↓ | ↓ | 0 | 640 |
| Example 2 | ↓ | ↓ | ↓ | ↓ | 0 | 0 | | 15.9 | μm | | 15 | μm | ↓ | ↓ | ↓ | ↓ | 0 | 960 |
| Example 3 | ↓ | ↓ | ↓ | ↓ | 0 | 0 | | 5 | μm | | 8.0 | μm | ↓ | ↓ | ↓ | ↓ | 0 | 515 |
| Example 4 | ↓ | ↓ | ↓ | ↓ | 0 | 0 | | 1.1 | μm | | 4.5 | μm | ↓ | ↓ | ↓ | ↓ | 0 | 285 |
| Example 5 | ↓ | ↓ | ↓ | ↓ | 0 | 0 | | 1.2 | μm | | 4.2 | μm | ↓ | ↓ | ↓ | ↓ | 0 | 270 |
| Example 6 | ↓ | ↓ | ↓ | ↓ | 0 | 0 | | 0.9 | μm | | 4.0 | μm | ↓ | ↓ | ↓ | ↓ | 0 | 255 |
| Example 7 | ↓ | ↓ | ↓ | ↓ | 0 | 0 | | 18.0 | μm | | 15 | μm | ↓ | ↓ | ↓ | ↓ | 0 | 960 |
| Example 8 | ↓ | ↓ | ↓ | ↓ | 0 | 0 | | 18.1 | μm | | 15 | μm | ↓ | ↓ | ↓ | ↓ | 0 | 960 |

| | B₂O₃ amount (ppm) | | | SiO₂ amount (ppm) | | | | | |
|---|---|---|---|---|---|---|---|---|---|
| | Surface | Center | | Surface | Center | | Reli- | Plating | |
| | area | area | | area | area | | ability | Elongation | L |
| | α1 | α2 | α2-α1 | β1 | β2 | β1-β2 | (h) | (μm) | (μH) |
| Comparative | 178.5 | 175.8 | −2.7 | 586.0 | 583.0 | 3.0 | 807 | 156.0 | 14.20 |
| example 1 | | | | | | | | | |
| Example 1 | 44.2 | 166.1 | 121.9 | 631.9 | 543.9 | 88.0 | 2013 | 35.1 | 14.14 |
| Example 2 | 43.6 | 263.6 | 220.0 | 955.0 | 831.2 | 123.8 | 2026 | 30.3 | 15.93 |
| Example 3 | 22.1 | 83.0 | 61.0 | 508.8 | 462.5 | 46.3 | 2184 | 17.3 | 12.27 |
| Example 4 | 2.1 | 18.5 | 16.4 | 278.6 | 158.4 | 120.2 | 2519 | 2.7 | 10.48 |
| Example 5 | 5.2 | 19.4 | 14.2 | 264.5 | 172.5 | 92.0 | 2461 | 5.6 | 10.52 |
| Example 6 | 11.3 | 15.3 | 4.0 | 251.1 | 189.3 | 61.8 | 2314 | 11.2 | 10.36 |
| Example 7 | 49.5 | 299.2 | 249.7 | 955.4 | 831.9 | 123.5 | 2002 | 39.2 | 17.81 |
| Example 8 | 49.6 | 300.0 | 250.4 | 955.3 | 831.9 | 123.4 | 1999 | 40.1 | 17.83 |

### Evaluation 1

According to the results shown in Table 1B, the examples in which the amount α1 of boron oxide near the surface was smaller than the amount α2 of boron oxide at the center area exhibited excellent high temperature humidity resistance reliability and plating property while maintaining a high inductance, compared to the comparative example. Comparative example 1 which the amount α1 of boron oxide in the area C2 near the surface of the magnetic element body 4 was greater than the amount α2 of boron oxide at the center area C1 exhibited a low reliability and also a poor plating property.

It was also confirmed that preferably α2−α1 was 4 ppm or greater, or more preferably α2−α1 was 4 ppm or greater and 250 ppm or less.

### Example 9

NiO, CuO, ZnO, and Fe₂O₃ were prepared, and these materials were blended. Then, calcination and pulverization were carried out to prepare a raw material powder. Note that, a blending ratio of each compound was, NiO: 11.5 mol %, CuO: 9.5 mol %, ZnO: 30 mol %, and Fe₂O₃: 49 mol %. A resin binder, a solvent, a plasticizer, and a dispersant were added to the obtained raw material powder to prepare a main component ferrite paste. The above-mentioned main component ferrite paste was used as an exterior ferrite paste. This exterior ferrite paste was printed on a PET film for several times; thereby, an exterior magnetic sheet 42 configuring the exterior region 2a was formed.

Also, a stacking unit 4π shown in FIG. 3A which configures an interior region 2b shown in FIG. 1 was prepared in the following steps. First, the main component ferrite paste not including a subcomponent was printed on the PET film not shown in the figure to form an interior magnetic sheet 40. On the interior magnetic sheet 40, a conductor pattern 50 made of Ag was printed to configure a coil conductor layer 5.

Using a printing method, a ferrite paste added with Li₂CO₃ was applied to a coil conductor inner part 40a so that a coating thickness was 10.0 μm. An amount of Li₂CO₃ in the exterior ferrite paste was adjusted to be 2600 ppm with respect to 100 parts by weight of the main component. Using a printing method, a ferrite paste was applied to a coil conductor outer part 40b so that a coating thickness was 10 μm. A thickness of the interior magnetic sheet 40 was 10 μm, and a thickness of the coil conductor layer 5 was 20 μm.

Then, the multilayer coil device was manufactured similarly to Example 1, and similar evaluations as in the case of Example 1 were carried out.

### <Composition Analysis>

A multilayer coil device is cut along the stacking direction, and a cross section was polished to give a polished surface. On the obtained cross section, the position on a center axis C0 which was 20 μm from the outer surface of the magnetic element body 4 (i.e., the area C2 near the surface of the magnetic element body 4) was subjected to a composition analysis using LA-ICP-MS, and the results were converted to values in terms of oxides (Li₂O); thereby, γ1 was obtained. Likewise, the composition analysis was performed to a center area C1 of the magnetic element body 4 along the center axis C0, and thereby γ2 was obtained. Table 2B shows the results. For each position, the composition of the main component was the same as the composition at the raw material stage. Table 2A shows the results.

Other than mentioned in above, the inductance, the reliability, and the plating elongation were evaluated similarly to Example 1. Table 2B shows the results.

### Examples 10 to 16

When forming the coil conductor inner part 40a on the interior magnetic sheet 40, a coating thickness of the inner ferrite paste added with Li₂CO₃ was adjusted to be a value shown in Table 2A.

When forming the coil conductor outer part 40b on the interior magnetic sheet 40, a coating thickness of the outer part ferrite paste added with Li₂CO₃ was adjusted to be a value shown in Table 2A.

The multilayer coil device was manufactured similarly to Example 9 other than mentioned in above, and similar evaluations as in the case of Example 9 were carried out. Table 2B shows the results.

### Comparative Example 2

When forming the exterior magnetic sheet 42, the amount of Li₂O in the ferrite paste was adjusted to be 800 ppm. The coil conductor inner part 40a and the coil conductor outer part 40b were not printed on the interior magnetic sheet 40, and the green multilayer body was manufactured. The multilayer coil device was manufactured similarly to Example 9 other than mentioned in above, and similar evaluations as in the case of Example 9 were carried out. Table 2B shows the results.

TABLE 2A
Coil conductor inner part Coil conductor outer part

| | Interior magnetic sheet | | | | | Coil conductor | | | Coil conductor | | | Exterior magnetic sheet | | | | |
|---|---|---|---|---|---|---|---|---|---|---|---|---|---|---|---|---|
| | Main | | | | Sub- | inner part | | | outer part | | | Main | | | | Sub- |
| | component | | | | component | Printing | | | Printing | | | component | | | | component |
| | (mol %) | | | | (ppm) | (Paste | Coated | | (Paste | Coated | | (mol %) | | | | (ppm) |
| | Fe₂O₃ | NiO | CuO | ZnO | Li₂O | application) | amount | | application) | amount | | Fe₂O₃ | NiO | CuO | ZnO | Li₂O |
| Comparative | 49.0 | 11.5 | 9.5 | 30.0 | 800 | No Printing | | | No Printing | | | 49.0 | 11.5 | 9.5 | 30.0 | 800 |
| example 2 | | | | | | | | | | | | | | | | |
| Example 9 | ↓ | ↓ | ↓ | ↓ | 0 | Printed | 10 | μm | Printed | 10 | μm | ↓ | ↓ | ↓ | ↓ | 0 |
| Example 10 | ↓ | ↓ | ↓ | ↓ | 0 | | 16 | μm | | 15 | μm | ↓ | ↓ | ↓ | ↓ | 0 |
| Example 11 | ↓ | ↓ | ↓ | ↓ | 0 | | 0.7 | μm | | 4.0 | μm | ↓ | ↓ | ↓ | ↓ | 0 |
| Example 12 | ↓ | ↓ | ↓ | ↓ | 0 | | 1.1 | μm | | 4.4 | μm | ↓ | ↓ | ↓ | ↓ | 0 |
| Example 13 | ↓ | ↓ | ↓ | ↓ | 0 | | 1.2 | μm | | 4.2 | μm | ↓ | ↓ | ↓ | ↓ | 0 |
| Example 14 | ↓ | ↓ | ↓ | ↓ | 0 | | 0.9 | μm | | 4.2 | μm | ↓ | ↓ | ↓ | ↓ | 0 |
| Example 15 | ↓ | ↓ | ↓ | ↓ | 0 | | 18.2 | μm | | 15 | μm | ↓ | ↓ | ↓ | ↓ | 0 |
| Example 16 | ↓ | ↓ | ↓ | ↓ | 0 | | 18.1 | μm | | 15 | μm | ↓ | ↓ | ↓ | ↓ | 0 |

TABLE 2B

| | Li₂O amount (ppm) | | | Reli- | Plating | |
|---|---|---|---|---|---|---|
| | Surface | Center | | ability | Elongation | L |
| | area γ1 | area γ2 | γ2-γ1 | (h) | (μm) | (pH) |
| Comparative | 650.0 | 648.6 | −1.4 | 814 | 153.3 | 19.86 |
| example 2 | | | | | | |
| Example 9 | 124.4 | 430.8 | 306.4 | 2069 | 32.8 | 14.14 |
| Example 10 | 153.0 | 531.2 | 378.2 | 2031 | 37.5 | 15.93 |
| Example 11 | 27.4 | 31.2 | 3.8 | 2185 | 5.7 | 10.27 |
| Example 12 | 5.2 | 47.4 | 42.2 | 2527 | 1.3 | 10.48 |
| Example 13 | 13.3 | 51.3 | 37.9 | 2466 | 2.9 | 10.52 |
| Example 14 | 35.5 | 39.5 | 4.0 | 2323 | 8.3 | 10.36 |
| Example 15 | 170.6 | 610.8 | 440.2 | 1998 | 39.3 | 17.83 |
| Example 16 | 170.5 | 610.4 | 439.9 | 2004 | 39.0 | 17.81 |

### Evaluation 2

According to the results shown in Table 2B, the examples which the amount γ1 of Li₂O in the area near the surface of the magnetic element body 4 was smaller than the amount 12 of Li₂O at the center area exhibited excellent high temperature humidity resistance reliability and plating property while maintaining a high inductance, compared to the comparative example. Comparative example 2 which the amount γ1 of Li₂O in the area C2 near the surface of the magnetic element body 4 was greater than the amount γ2 of Li₂O at the center area C1 exhibited a low reliability and also a poor plating property.

It was also confirmed that preferably γ2−γ1 was 4 ppm or greater, or more preferably γ2−γ1 was 4 ppm or greater and 250 ppm or less.

### REFERENCE SIGNS LIST

1 . . . Multilayer coil device
2 . . . Element main body
2a . . . Exterior region
2b . . . Interior region
2b1 . . . Coil conductor inside region
2b2 . . . Coil conductor outside region
3 . . . Terminal electrode
3a . . . Underlayer
3b to 3c . . . Plating layer
4 . . . Magnetic element body (ferrite sintered body)
4a . . . Magnetic material layer
4a, 4B . . . Stacking unit
40 . . . Interior magnetic sheet
40a . . . Coil conductor inner part
40b . . . Coil conductor outer part
41 . . . Hole
42 . . . Exterior magnetic sheet
5 . . . Coil conductor layer
5a1, 5a2 . . . Lead electrode
50 . . . Conductor pattern

What is claimed is:

1. A ferrite sintered body, comprising:
boron oxide, an amount of boron oxide near a surface of the ferrite sintered body being smaller than an amount of boron oxide at a center area of the ferrite sintered body.

2. The ferrite sintered body according to claim 1, wherein the amount of boron oxide near the surface of the ferrite sintered body represented by α1 and the amount of boron oxide at the center area of the ferrite sintered body represented by α2 satisfy a relation of α2-α1 of 4 ppm or greater.

3. The ferrite sintered body according to claim 2, wherein α2-α1 is 250 ppm or less.

4. The ferrite sintered body according to claim 1 further comprising silicon oxide.

5. The ferrite sintered body according to claim 4, wherein an amount of silicon oxide near the surface of the ferrite sintered body is greater than an amount of silicon oxide at the center area of the ferrite sintered body.

6. The ferrite sintered body according to claim 5, wherein the amount of silicon oxide near the surface of the ferrite sintered body represented by β1 and the amount of silicon oxide at the center area of the ferrite sintered body represented by β2 satisfy a relation of β1-β2 of 10 ppm or greater.

7. A ferrite sintered body, comprising:
lithium oxide, an amount of lithium oxide near a surface of the ferrite sintered body being smaller than an amount of lithium oxide at a center area of the ferrite sintered body.

8. The ferrite sintered body according to claim 7, wherein the amount of lithium oxide near the surface of the ferrite sintered body represented by γ1 and the amount of lithium oxide at the center area of the ferrite sintered body represented by γ2 satisfy a relation of γ2-γ1 of 4 ppm or greater.

9. The ferrite sintered body according to claim 8, wherein γ2-γ1 satisfy 440 ppm or less.

10. The ferrite sintered body according to claim 1 comprising a Ni—Cu—Zn based ferrite.

11. An electronic device, comprising:
a magnetic element body and a coil conductor installed in the magnetic element body, wherein the magnetic element body includes the ferrite sintered body according to claim 1.

12. The ferrite sintered body according to claim 7 comprising a Ni—Cu—Zn based ferrite.

13. An electronic device, comprising:
a magnetic element body and a coil conductor installed in the magnetic element body, wherein the magnetic element body includes the ferrite sintered body according to claim 7.
